(19) United States
(12) Patent Application Publication
(10) Pub. No.: US 2026/0217498 A1
(43) Pub. Date: Jul. 30, 2026

(54) CRANE SYSTEM INCLUDING A TUGGER WINCH AND TUGGER LINE

(71) Applicant: Itrec B.V., SCHIEDAM (NL)

(72) Inventor: Lucas BOONTJES, SCHIEDAM (NL)

(73) Assignee: Itrec B.V., SCHIEDAM (NL)

(21) Appl. No.: 19/149,038

(22) PCT Filed: Jan. 17, 2024
(86) PCT No.: PCT/EP2024/050967

§ 371 Date: Jul. 17, 2025

(30) Foreign Application Priority Data
Jan. 18, 2023 (NL) 2033982
Aug. 21, 2023 (NL) 2035649

(51) Int. Cl. B66C 13/06; B63B 35/00; B66C 23/18; B66C 23/52; E02B 17/00; E02B 17/02; E02D 13/00

(52) U.S. Cl. CPC B66C 13/06; B63B 35/003; B66C 23/185; B66C 23/52; E02B 17/024; E02D 13/00; E02B 2017/0039; E02B 2017/0065; E02B 2017/0091

(57) ABSTRACT

The present invention relates to a method, a vessel and a crane system for use on a vessel, e.g. for handling an object such as a monopile for an offshore wind turbine. The crane system comprises a crane having a hoisting winch with an associated hoisting cable and a load connector for suspending the object, as well as a tugger assembly comprising a tugger winch with an associated tugger line which is connectable to the object or to the load connector. The crane system further comprises a damping cylinder supporting one or more sheaves over which the tugger line is guided. Movement of the object in the horizontal direction puts a load on the damping cylinder via the tugger line. The load on the damping cylinder moves the piston assembly of the damping cylinder, to thus dissipate kinetic energy of the object and damp motion of the object.

### FIELD OF THE INVENTION

The present invention relates to a method, a vessel, and a crane system comprising a crane having a hoisting winch with an associated hoisting cable and a load connector for suspending an object, e.g. a monopile adapted to support an offshore wind turbine. The crane system further comprises a tugger assembly with a tugger winch with an associated tugger line which is connectable to the object or to the load connector.

### BACKGROUND OF THE INVENTION

An example of a crane system according to the preamble of claim 1 is presented in WO2020212409. This known crane system is arranged on a vessel and is employed, for example, in the course of installation of a monopile into the seabed. The vessel is equipped with a pile holding system comprising a support structure mounted to a deck of the vessel and a pile holder supported by the support structure. The pile holder includes gripping devices provided with rollers that engage on the monopile as it is lowered by the crane onto the seabed. The monopile is configured to serve as foundation for an offshore wind turbine. As explained in this document, such monopiles may be larger than 100 meters in length and may weigh more than 1000 tonnes. When the vessel is in floating condition and/or due to influences like waves when the monopile enters the splash zone and/or wind forces acting on the suspended monopile, the pile may sway, e.g. in a pendulum-like motion, as it is suspended from the crane.

In WO2020212409 it is disclosed to install the monopile by means of the crane system and the pile holding system of the vessel using a method comprising the following steps:
a. suspending the monopile from a hoisting cable in a substantially vertical orientation;
b. providing a lower end of the monopile in a pile holding system limiting horizontal motion of a pile portion held by the pile holding system; and
c. lowering the monopile with the pile being held by the pile holding system, wherein lowering includes at least lowering the monopile through a splash zone of a body of water,
   wherein during step c), two tugger lines are directly or indirectly connected to the pile at a location between the pile holding system and the hoisting cable, said tugger lines being operated to dampen motion of the pile in two respective horizontal directions.

The crane system of WO2020212409 is not fully satisfactory. Therefore, it is an object of the invention to provide an improved crane system, e.g. use onboard of a vessel e.g. for installation of a monopile adapted to support an offshore wind turbine, which crane system allows for effective use thereof in adverse conditions as well, e.g. with harsh wind and wave conditions.

From WO2021245175 an installation facility is known for installing a pile in a vertical orientation on a target pile position into a seabed and methods thereof. The installation facility comprising a vessel with a deck for storing a plurality of piles, a lifting crane fixed to the vessel, a global positioning system for receiving global positioning coordinates, a vessel motion sensor and an installation tool fixed to an outer boundary of the deck for installation of the pile onto the seabed. The installation tool comprises a pile motion sensor for measuring the movements of the pile relative to the global positioning coordinates at the target pile position and a pile gripper allowing dampening of pile movements.

### SUMMARY OF THE INVENTION

The invention provides a crane system according to the preamble of claim 1, which is characterized in that the crane system further comprises a damping assembly having a damping cylinder supporting one or more sheaves over which the tugger line is guided between the tugger winch and the object or the load connector, wherein the damping cylinder comprises a cylinder body and a piston assembly delimiting a rod-side chamber and a piston-side chamber of the damping cylinder, wherein movement of the object in the horizontal direction puts a load on the damping cylinder via the tugger line, the load on the damping cylinder moving the piston assembly of the damping cylinder, to thus dissipate kinetic energy of the object and damp motion of the object.

### OBJECT OF THE INVENTION

With such a crane system an object, e.g. a (mono-)pile, can be installed with the damping cylinder being used to damp motion of the object in the horizontal direction. The tugger line is guided over one or more sheaves of the damping cylinder, such that movement of the object in the horizontal direction puts a load on the damping cylinder. Depending on the configuration, the cylinder is compressed or extended under the load provided by the tugger line. The movement of the piston assembly of the cylinder dissipates kinetic energy of the object to thus damp motion of the object.

By utilising a damping cylinder instead of the tugger winch for damping the movement of the object, a smaller winch can be used. Also, because the winch is not used for damping the movement of the object, quick switching of the winch is not required, and therefore an electric winch can be used instead of a hydraulic winch.

Providing a damping cylinder for damping the movement of the object instead of using the tugger winch itself, allows for a more robust tugger assembly. The winch no longer needs to quickly change between paying in and paying out tugger line, and the tugger line is not repeatedly wound on and off the tugger winch. Therefore, the mechanical load in the tugger line is reduced, and the chance of failure of the tugger line is reduced. Also, inspection and/or replacement of the tugger lines is needed less frequent compared to a tugger assembly wherein the winch is used for damping the movement of the pile.

In an embodiment, the damping cylinder is a passive hydraulic damping cylinder, and a hydraulic circuit is provided that connects the hydraulic damping cylinder to a hydraulic accumulator.

In an embodiment, the cylinder is provided with a hydraulic bypass loop, to facilitate movement of the piston assembly, and thus facilitate adjusting the position of the piston assembly in the cylinder body using the tugger winch.

In embodiments, the damping assembly further comprises:
an accumulator assembly with a pressurized gas filled chamber and with a hydraulic chamber which is pressurized by the gas in the gas filled chamber via a medium separator of the accumulator assembly,
a hydraulic circuit in communication with the hydraulic chamber of the accumulator assembly and connected to each of the rod-side chamber and the piston-side chamber of the damping cylinder,
   wherein the hydraulic circuit comprises:
a first flow control valve to control flow between the rod-side chamber and the accumulator assembly,
preferably, a first pressure relief valve associated with the rod-side chamber and configured to prevent overpressurization of the rod-side chamber when the first flow control valve is closed,
a second flow control valve to control flow between the piston-side chamber and the accumulator assembly,
a second pressure relief valve associated with the piston-side chamber and configured to allow for flow of hydraulic liquid out of the piston-side chamber upon reaching a threshold force of the tugger line on the piston assembly,
   wherein a bypass channel extends directly between the rod-side chamber and the piston-side chamber of the damping cylinder, and wherein a throttle is provided in the bypass channel.

For example, when the crane system is used in a method for installation of a monopile adapted to support an offshore wind turbine, the damping assembly is used to dampen motion of the monopile in the horizontal direction, in particular during the phase of lowering the monopile towards the seabed. For example, one or two tugger lines are connected, directly or indirectly (e.g. via the monopile lifting tool or a hoist block of the crane), to the monopile. During this phase, e.g. due to external factors like waves, wind, crane motion, the pile top end may suddenly move at a rather high speed or acceleration causing initially an increased tension on the tugger line or a rather rapid drop of tugger line tension. Whilst the tugger winch may be controlled, e.g. in a constant tension mode, to maintain a rather even line tension, the tugger winch is likely to be too slow to absorb such an event. In the inventive crane system, the damping cylinder will react quickly to the event. The initial motion of the top end of the monopile is followed by an oscillation phase of the top end, and during this phase the damping cylinder will operate so as to gradually dampen the oscillation. This involves reciprocation of the piston assembly within the cylinder of the damping cylinder.

In this arrangement, the tugger winch does not have to be operated and/or be configured so as to quickly respond to the, e.g. sudden, lateral motion of the monopile. This allows for a less complex design of the tugger winch and/or for a smaller capacity tugger winch, e.g. of the tugger winch drive motor.

In view of this reciprocating motion of the piston assembly of the damping cylinder, it is desired that such motion takes place about a central position, e.g. with the piston in the middle or mid-position of the cylinder body so that an effective stroke is present both in outward and inward direction. In practical operation, the actual central position of the reciprocating piston assembly tends to shift relative to the desired central position. If this were allowed to happen, the effective stroke in one direction of the piston assembly would become smaller, eventually reaching an end position thereof wherein motion in one direction is impossible. This effect would impair the damping function. The presence of the external bypass channel which extends between the rod-side chamber and the piston-side chamber of the damping cylinder, and of the throttle, which is provided in the external bypass channel, contributes to countering the undesired shift from the desired central position. The bypass arrangement allows for a bypass flow, in practical embodiments a limited bypass flow, directly between the chambers of the damping cylinder. This has the effect that the piston assembly will have a slow tendency to move to the desired central position in operation of the damping assembly.

In an embodiment, the throttle is a fixed throttle. In another embodiment, the throttle is an adjustable throttle.

In an embodiment, the external bypass channel and the throttle in the external bypass channel provide for a maximum flow rate there through which is less than 10% of the smallest one of the maximum flow rate to the rod-side chamber and to the piston-side chamber of the damping cylinder. More preferably this percentage is less than 5%. For example, in an embodiment, the maximum flow rate through the external bypass channel and the throttle in the external bypass channel is less than 50 litres per minute, with the smallest one of the maximum flow rate to the rod-side chamber and to the piston-side chamber being 1000 litres per minute. For example, the maximum flow rate to the rod side chamber is smaller than to the piston-side chamber, e.g. 1000 litres per minute versus 2200 litres per minute.

In an embodiment, the crane system further comprises a control system to control damping motion of the pile in a horizontal direction using the damping cylinder.

In an embodiment, the tugger winches each have a tension control mode wherein each winch operates to exert a selected tension on the tugger line.

In an embodiment—in operation of the damping assembly—the tugger winch is operated in tension control mode, wherein the tension of the tugger line is set at a fixed tension setpoint that corresponds to the pressure in the damping cylinder when in the desired central position.

In embodiments, sensors are provided for measuring position, acceleration, and direction of movement of the pile relative to the vessel, and the control system is configured to control the tugger assembly on the basis of measurements provided by the sensors.

In embodiments, sensors are provided for measuring position, acceleration and direction of movement of the piston assembly relative to the cylinder body, and the control system is configured to control the piston assembly on the basis of measurements provided by the sensors, preferably to cause the piston assembly to assume an intermediate position, e.g. midway, along the cylinder body, when there is no substantial horizontal movement of the object. For example, the damping cylinder is provided with a position sensor which monitors the position of the piston assembly relative to the cylinder body. Advantageously, the tugger winch has a drive with a drive controller which is linked to the position sensor, and the drive controller is configured to control operation of the winch so that the piston assembly is moved to the desired central position thereof. So, based on this control arrangement, there is a further counter measure for the shift of the central position.

In embodiments, the winch is held non-rotative when horizontal movement of the object puts a load on the associated tugger line, said movement of the object thus causing compression or extension of the damping cylinder. Thus, the movement of the object is fully transferred in a load on the cylinder. It is noted that when the object is lifted or lowered while the movement of the object in the horizontal direction is damped, holding the winch non-rotative may cause a shift of the neutral position of the cylinder, more in particular of the piston assembly in the cylinder body of the cylinder. This shift in the neutral position can be adjusted for by adjusting the pressure in the cylinder, or with the tugger winch after the movement of the object is damped.

In an embodiment, the tugger assembly is arranged on the crane, preferably on a luffing frame of the crane.

In an embodiment, the tugger winch is arranged on the crane.

In an embodiment, the tugger assembly is a first tugger assembly, and the vessel comprises a second tugger assembly, wherein the second tugger assembly is similar to the first tugger assembly, wherein the tugger control system controls the first tugger assembly and the second tugger assembly, and wherein the two tugger assemblies are positioned on a left side and a right side of the crane respectively.

In an embodiment, waves in the body of water, i.e. the sea, have a wave propagation direction seen in plan view. Further, two tugger assemblies are provided and one of the two tugger lines, i.e. a first tugger line, extends from the load connector in a first tugger pull direction seen in plan view while the other one of the two tugger lines, i.e. a second tugger line, extends from the load connector in a second tugger pull direction seen in plan view. The first and second tugger pull directions define an interior bisector dividing an angle between the first and second tugger pull directions into two equal parts. Preferably, the first and second tugger pull directions are positioned such that the wave propagation direction is in between a direction perpendicular to the bisector and a direction perpendicular to the first tugger pull direction or in between a direction perpendicular to the bisector and a direction perpendicular to the second tugger pull direction. An advantage thereof may be that during the entire period of an object eigenmode, at least one of the two tugger lines is able to apply a pulling force to the object which results in a more effective damping of the eigenmode.

In an embodiment, operation of the tugger line is controlled in dependency of control of the lowering of the object as the tugger line also has to follow the lowering of the object even in case no motion is to be damped.

In embodiments, the crane system has two tugger winches and corresponding tugger lines, as well as two corresponding damping assemblies, configured for damping in at least two different horizontal directions.

In embodiments, two similar tugger assemblies are used, wherein the tugger assemblies are set up such that the tugger line, when connected to the load connector or the object, enclose an angle, the angle preferably having a boom of the hoisting device at its centre line. It is submitted that it is generally known in the prior art to use two tugger assemblies in such a set up, typically on opposite sides of a boom of the hoisting device. This configuration allows for a triangular support of the object, using the two tugger lines and the hoisting wire, and thus for a more stable support of the object.

In embodiments the damping cylinder is provided with a threshold pressure of at least 200 bar, for example 250 bar, such that the damping only occurs when the load on the cylinder exceeds the threshold pressure. A threshold pressure of at least 200 bar is in particular desirable when using two tugger assemblies, when only a single tugger assembly is sued, a higher threshold may be used.

The present invention also relates to a vessel provided with a crane system as described herein.

The present invention also relates to a vessel configured for installation of a monopile adapted to support an offshore wind turbine, the vessel comprising a crane system as described herein and further a pile holding system with a support structure mounted to the hull, e.g. a deck, of the vessel and a pile holder supported by the support structure, e.g. wherein the pile holder includes gripping devices provided with rollers that engage on the monopile as it is lowered by the crane towards the sea bed.

In a practical embodiment, for example, the damping assembly is operated when the monopile is being lowered toward the seabed by means of the crane and being guided by the pile holding system.

Possible actions of the system when the monopile is being lowered toward the seabed by means of the crane and being guided by the pile holding system are:
1) if suddenly the pile top end moves outward at high speed or acceleration, tugger line pull will increase faster than the tugger winch can follow, and the piston assembly will be pushed in by force. The hydraulic damping assembly will brake/dampen the outward motion.
2) the pile top moves inward/back, the piston assembly will follow the motion by quickly extending preventing slack rope on the tugger line.
actions 1 and 2 will repeat and energy will be dissipated until pile top end speed is in range of the tugger winch speed again. Then the system will balance out with the piston assembly of damping cylinder in approximately the desired central position.

Possible actions of the system when the monopile is being lowered toward the seabed by means of the crane and being guided by the pile holding system are:
1) if suddenly the pile top end moves inward at high speed or acceleration, tugger line pull will decrease faster than the tugger winch can follow, and the piston assembly of the damping cylinder will extend by the accumulator pressure. The rod will follow the pile top end motion by quickly extending, thereby preventing slack rope on the tugger line.
2) the pile top end moves outward at high speed or acceleration; tugger line pull will increase faster than the tugger winch can follow, and the piston assembly of the damping cylinder will be pushed in by force. The hydraulic damping assembly will brake/dampen the outward motion.
actions 1 and 2 will repeat and energy is dissipated until pile top end speed is in range of the tugger winch speed again. Then the damping assembly will balance out with the piston assembly of damping cylinder in approx. the desired central position.

For example, once the seabed is reached by the monopile, the hydraulic damping assembly is switched off. For example, the damping cylinder is hydraulically locked by closing both flow control valves. For example, once the hydraulic damping assembly is switched off, the tugger winch(es) is/are set at another constant tension set point than during the operative phase of the damping assembly.

The invention furthermore provides a vessel for installation of an object adapted to support an offshore wind turbine, said vessel comprising:
a crane with hoisting winch and an associated hoisting cable and load connector, for suspending the object in a substantially vertical orientation;
a pile holder to hold the object and limit horizontal motion of an object portion held by the pile holder;
a tugger assembly, the tugger assembly comprising a tugger winch with an associated tugger line, and
a damping cylinder supporting one or more sheaves; and
   a control system for controlling the tugger assembly, to damp motion of the object in a horizontal direction using the tugger assembly, wherein the tugger line is guided via the one or more sheaves of the damping cylinder, and, for damping the motion of the object, the tugger line is to be connected to the load connector or the object.

In an embodiment, the crane comprises a hoisting control system for controlling the hoisting winch to lower the object, optionally with the object being held by the pile holder, using the hoisting winch.

In an embodiment, the pile holder is configured to move in two horizontal directions, and there is a control system that controls both the movement of the pile holder and the tugger control system, to use the tugger assembly and the pile holder in combination to dampen horizontal movement of the object.

In embodiments, while the object is being lowered, the object is held in a pile holder to limit horizontal motion of the object portion held by the pile holder. In such a method, the pile holder is used to guide and position the object while being lowered towards the seafloor. The pile holder holding the object makes that the pile holder forms a hinge point for the movement of the object. In particular when the lower end of the object passes the splash zone, this may enlarge the horizontal movement of the top end of the object, when the lower end of the object is excited by the waves. Therefore, the pile holder preferably engages the object only after at least the lower end of the object has passed through the splash zone.

In embodiments, the pile holder is configured to be moved relative to the vessel in a horizontal direction. In such an embodiment, both the tugger assembly and the pile holder can be used together to dampen horizontal movement of the object, by moving the object gripper in a horizontal direction relative to the vessel while using the tugger assembly to dampen the movement of the object.

In addition or as an alternative, the pile holder is provided with object engagement devices that are configured to dampen movement of the object in a horizontal direction. In such an embodiment, the interface between pile holder and object is configured to dampen motion of the object in a horizontal direction, and it is not required for the pile holder to be moved in a horizontal direction to dampen movement of the object.

It is observed that the tugger assembly is mounted on the vessel, preferably is mounted on the crane, such that movement of the object away from the vessel and the crane makes that the tugger lines are loaded, while a movement in the opposite direction unloads the tugger line. To prevent slack in the tugger line, typically the tugger winch is used to the keep a minimum load on the tugger line by paying in tugger line. However, with a tugger assembly according to the invention, preferably the cylinder is sued to keep a minimum load on the tugger line, and thus prevent slack.

The present invention also relates to a method for handling of an object such as a monopile adapted to support an offshore wind turbine, wherein use is made of a crane system as described herein.

In embodiments, the method is a method for installation of a monopile adapted to support an offshore wind turbine, wherein use is made of a vessel as described above, said method preferably comprising the following steps:
suspending the monopile from the hoisting cable via a load connector in a substantially vertical orientation;
preferably connecting the tugger line to the object or to the load connector and operating the tugger line to dampen motion of the pile in a horizontal direction,
lowering the monopile through a splash zone of a body of water, and damping motion of the monopile in a horizontal direction using the damping cylinder.

In embodiments, the method further comprises the step of holding the tugger winch non-rotative when horizontal movement of the object puts a load on the associated tugger line, said movement of the object thus causing compression or extension of the damping cylinder.

In embodiments, the position, and preferably the acceleration and direction of movement, of the object relative to the vessel are measured, and the tugger assembly is controlled on the basis of these measurements. For example, by measuring the position and the speed of the object, the speed of paying in, or of paying out, the tugger line can be controlled. It is submitted that information on the position and the speed of the object can for example be obtained by measuring the speed and position of the hoisting wire. By obtaining information on the position and speed of the object, it can for example be prevented that due to lowering the object, the load on the tugger line is increased, and therefore the load on the damping cylinder is increased, reducing the ability of the damping cylinder to efficiently dampen the movement of the object.

In embodiments, the method comprises the steps of measuring position, acceleration and direction of movement of the piston assembly relative to the cylinder body and controlling the tugger winch and damping cylinder on the basis of measurements provided by the sensors, preferably to cause the piston assembly to assume an intermediate position, e.g. midway, along the cylinder body, when there is no substantial horizontal movement of the object. In such an embodiment, a control system can be used to not only position the cylinder in a neutral position, e.g. with the piston halfway the cylinder body, that allows for damping the movement of the object, but also to actively monitor and correct the position of the cylinder. When for example the neutral position of the cylinder shifts during the damping of the object and the lowering of the object, the system can be used to readjust the neutral position of the piston assembly, for example by paying in more tugger line to increase the load on the piston assembly and move it towards the initial neutral position.

Herein the term neutral position is used to indicate the position of the piston assembly in the cylinder body when there is no damping, i.e. when there is no horizontal movement of the object that puts a load on the cylinder. In this neutral position the cylinder can move in two directions inside the cylinder, i.e. the piston assembly is not fully extended or fully retracted.

Thus, when the piston assembly is in the neutral position, the piston assembly can be moved in a damping direction, allowing for movement of the object that pulls on the tugger line and thus causes a load to be exerted on the piston assembly, and in a reset direction, i.e. in a direction opposite the damping direction, allowing for movement of the object in a direction that unloads the tugger line.

According to a second aspect of the invention, there is provided a vessel for installation of a pile adapted to support an offshore wind turbine, said vessel comprising:
a crane with a hoisting cable and hoisting winch to suspend the pile in a substantially vertical orientation and to lower the pile;
a pile holding system to hold the pile and limit horizontal motion of a pile portion held by the pile holding system;
a tugger system including two tugger lines and corresponding tugger winches, said tugger lines being directly or indirectly connectable to the pile at a location between the pile holding system and the hoisting cable; and
a control system for controlling the hoisting winch and the two tugger winches to lower the pile with the pile being held by the pile holding system using the hoisting winch and to damp motion of the pile in two respective horizontal directions using the two tugger winches.

In an embodiment, the tugger system is provided on the crane.

In an embodiment, the crane comprises a boom rotatably connected to a structure to rotate about a substantially horizontal rotation axis, wherein the structure preferably comprises a spreader to guide the two tugger lines at opposite sides of the boom towards the location between the pile holding system and the hoisting cable.

In an embodiment, the tugger line or tugger lines are to be connected to an upper end of the pile.

In an embodiment, the tugger line or tugger lines are to be connected to the load connector suspended by the hoisting cable.

In an embodiment, the tugger line or tugger lines are to be connected to an attachment device between the load connector and the upper end of the pile.

In an embodiment, the two tugger lines include a first tugger line and a second tugger line, wherein the tugger system further comprises a first tugger winch for the first tugger line and a second tugger winch for the second tugger line, and wherein preferably the first and second tugger winches are arranged on the crane, e.g. on the structure or the boom of the crane.

In an embodiment, the tugger system includes a first tugger sheave to guide the first tugger line between the first tugger winch and the load connector, and a second sheave to guide the second tugger line between the second tugger winch and the load connector, wherein preferably the first and second sheave are arranged on the spreader.

It will be appreciated by the skilled person that a technical feature discussed herein as required or as optional with respect to one embodiment of the invention may be equally applicable to one or more other embodiments described herein, with the feature performing its designation function. Such combinations are all envisaged herein unless a combination would result in a technical impossible solution and/or not meet the desired functionality.

The invention is by no means limited to the exemplary embodiment described herein above, but comprises various modifications hereto, in so far as they fall within the scope of the following claims. Other variations to the disclosed embodiments can be understood and effected by those skilled in the art in practicing the claimed invention, from study of the drawings, the disclosure, and the appended claims. In the claims, the word “comprising” does not exclude other elements or steps, and the indefinite article “a” or “an” does not exclude a plurality. Any reference signs in the claims should not be construed as limiting the scope.

### BRIEF DESCRIPTION OF THE DRAWINGS

The invention will now be explained with reference to the drawings.

In the drawings:

FIG. 1 shows a vessel 1 for installation of a monopile to support an offshore wind turbine,

FIG. 2 shows the crane system of the vessel of FIG. 1,

FIG. 3 shows an example of the reeving of a tugger line in the crane system of FIG. 2,

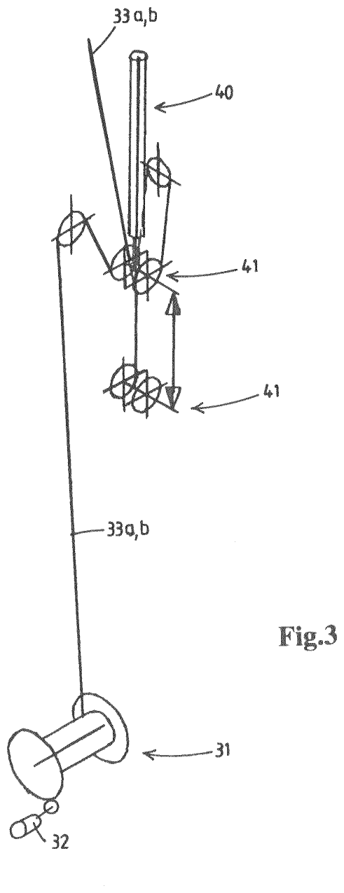

FIG. 4 shows schematically an example of the damping assembly of the crane system of FIG. 3,

FIG. 5 shows schematically a further development of the damping assembly of FIG. 4.

### DETAILED DESCRIPTION OF EMBODIMENTS

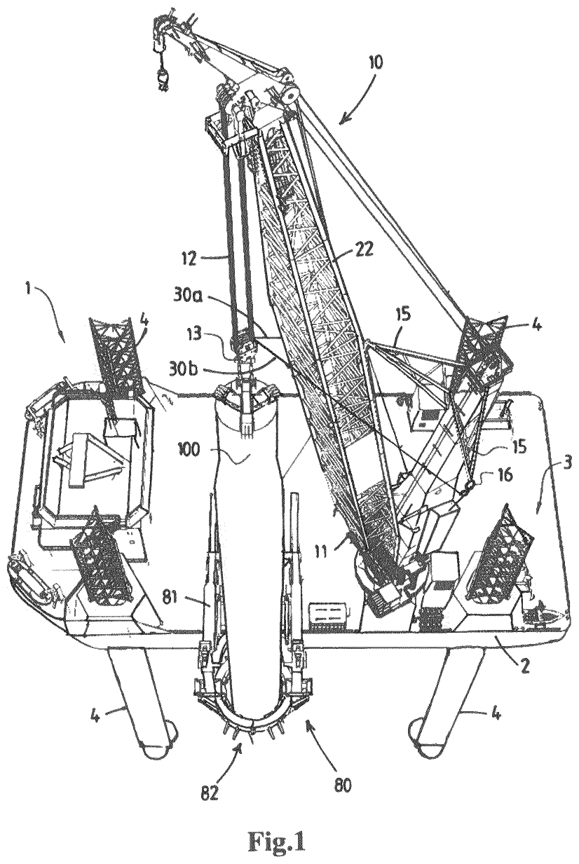

FIG. 1 shows a vessel 1 which is configured for installation of a monopile 100 adapted to support an offshore wind turbine.

The vessel 1 has a hull 2 with a deck 3. Here, by way of example, the vessel 1 is a jack-up vessel with jack-up legs 4 and associated jacking mechanisms.

The vessel 1 is equipped with an example of the inventive crane system.

The vessel 1 is also equipped with a pile holding system 80 having a support structure 81 which is mounted to the hull, here to the deck 3, of the vessel, a pile holder 82 which is supported by the support structure 81. As is known in the art, the pile holder 82 includes gripping devices provided with rollers that engage on the monopile 100 as it is lowered by the crane of the crane system 1 towards the seabed.

The crane system comprises a crane 10 having a hoisting winch 11 with an associated hoisting cable 12 and a load connector 13 for suspending an object, e.g. a monopile 100 adapted to support an offshore wind turbine.

The crane 10 has a base or pedestal 20 joined to the hull 2 and a slewable superstructure 21 with a luffable boom 22. The boom 22 luffing is possible by means of a luffing assembly with luffing cable(s) 23 and one or more associated luffing winches.

The crane system further comprises a tugger assembly, here two tugger assemblies, each comprising a tugger winch 31 mounted to the crane, here in a box 34.

Each tugger winch has a drum driven by a corresponding drive motor 32. Each winch 31 has an associated tugger line 33a, b. in this example, the crane has outriggers 15 provided with a sheave 16 over which the tugger line 33a, b passes.

In this example, both tugger lines 33a, b are connected to the load connector 13, each line in a different direction. This allows for damping in at least two different horizontal directions.

The crane system further comprises a damping assembly which comprises:
a damping cylinder 40 supporting one or more sheaves 41 over which the tugger line is guided between the tugger winch 33 and the load connector 13, wherein the damping cylinder comprises a cylinder body 40a and a piston assembly 40b delimiting a rod-side chamber 45 and a piston-side chamber 46 of the damping cylinder 40,
an accumulator assembly 50 with a pressurized gas filled chamber 51 and with a hydraulic chamber 52 which is pressurized by the gas in the gas filled chamber via a medium separator of the accumulator assembly,
a hydraulic circuit in communication with the hydraulic chamber 52 of the accumulator assembly 50 and connected to each of the rod-side chamber 45 and the piston-side chamber 46 of the damping cylinder.

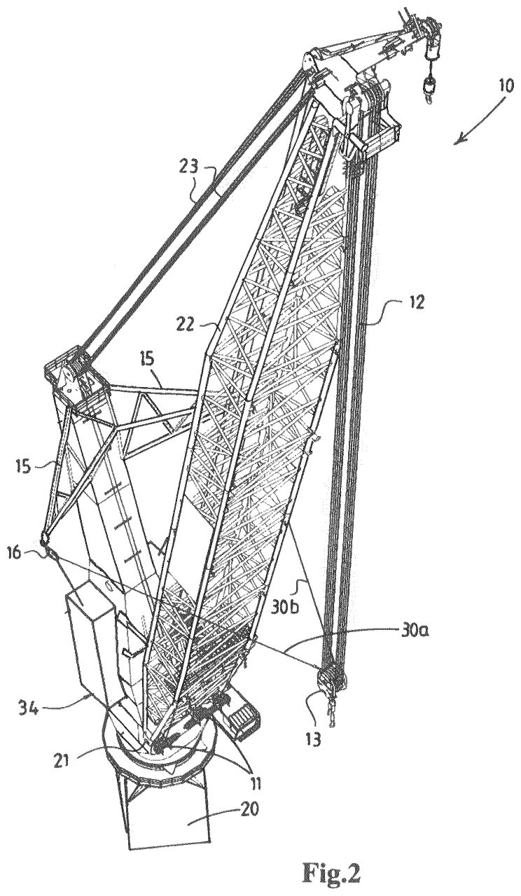

In the FIG. 2 the stroke of the damping cylinder 40 is depicted by two positions of sheaves 41.

In FIG. 2 it is shown, by way of example, that there are two sheaves 41 for each damping assembly, such that a four-fold reeving of the lines 33a, b is provided for.

The hydraulic circuit comprises:
a first flow control valve 60 to control flow between the rod-side chamber 46 and the accumulator assembly 50,
a first pressure relief valve 61 associated with the rod-side chamber 46 and configured to prevent overpressurization of the rod-side chamber when the first flow control valve 60 is closed,
a second flow control valve 65 to control flow between the piston-side chamber and the accumulator assembly,
a second pressure relief valve 66 associated with the piston-side chamber 46 and configured to allow for flow of hydraulic liquid out of the piston-side chamber upon reaching a threshold force of the tugger line 33a, b on the piston assembly 40b.

In this example, the first flow control valve 60 and the first pressure relief valve 61 are arranged in parallel.

In this example, the second pressure relief valve 66 is arranged in parallel with a check valve 67, and in series with the second flow control valve 65.

A bypass channel 70 extends directly between the rod-side chamber 45 and the piston-side chamber 46 of the damping cylinder. A throttle 71 is provided in the bypass channel.

The throttle 71 is a fixed throttle in this example, but an adjustable throttle is also envisaged.

In this example, the external bypass channel is configured to provide a direct, non-valved communication between the rod-side chamber 46 and the piston-side chamber 45.

The external bypass channel 70 and the throttle 71 in the external bypass channel are configured to provide for a maximum flow rate there through which is less than 10% of the smallest one of the maximum flow rate to the rod-side chamber 45 and to the piston-side chamber 46 of the damping cylinder 40, preferably less than 5%.

The tugger winch 31 has a tension control mode wherein the winch operates to exert a selected tension on the tugger line 33a,b.

The damping cylinder is provided with a position sensor 48 which monitors the position of the piston assembly 40b relative to the cylinder body 40a, and wherein the tugger winch 31 has a drive 32 with a drive controller which is linked to the position sensor 48, and wherein the drive controller is configured to control operation of the winch.

As shown in FIG. 1 it is envisaged that the crane system is used in the installation of a monopile 100 in cooperation with the holding system pile holding system 80. In particular it is shown that the top end of the monopile suspended from the crane 10 is controlled by the tugger lines 33a, b, which here engage on the load connector 13, here embodied as a hoisting block of the crane 10.

The damping assembly is operated when the monopile is being lowered toward the seabed by means of the crane and being guided by the pile holding system.

As discussed, during the lowering of the monopile to the seabed, sudden lateral motions of the top end of the monopile 100 may occur. Whilst the tugger winch 31 may be controlled, e.g. in a constant tension mode, to maintain a rather even line tension during this stage, the tugger winch 31 is likely to be too slow to absorb such an event. In the inventive crane system, the damping cylinder 40 will react quickly to the event. The initial motion of the top end of the monopile is followed by an oscillation phase of the top end, and during this phase the damping cylinder 40 will operate so as to gradually dampen the oscillation. This involves reciprocation of the piston assembly within the cylinder of the damping cylinder. Therefore, the damping assembly enhances the effect of the tugger lines 33a, b and effectively dampens the undesired motion of the monopile 100.

For example, the valve 66 is configured to open at a pressure of 250 bars, which corresponds to a certain load on the piston assembly 40b by the tugger line 33a, b.

For example, the valve 60 is configured to open at a pressure of 250 bars in order to avoid undue pressure rise within the damping cylinder when the valves 60, 65 are closed.

For example, the pressure resulting from the accumulator assembly is 50 bars.

In view of the reciprocating motion of the piston assembly of the damping cylinder, it is desired that such motion takes place about a central position, e.g. with the piston in the middle or mid-position of the cylinder body 40a so that an effective stroke is present both in outward and inward direction.

For example, the stroke length is at least 2 meters, e.g. at least 4 meters.

In practical operation, the actual central position of the reciprocating piston assembly 40b tends to shift relative to the desired central position. If this were allowed to happen, the effective stroke in one direction of the piston assembly 40b would become smaller, eventually reaching an end position thereof wherein motion in one direction is impossible.

This effect would impair the damping function. The presence of the external bypass channel 70 and of the throttle 71 contributes to countering the undesired shift from the desired central position. The bypass arrangement allows for a rather small bypass flow directly between the chambers of the damping cylinder. This has the effect that the piston assembly will have a slow tendency to move to the desired central position in operation of the damping assembly.

For example, the maximum flow rate through the external bypass channel 70 and the throttle 71 is less than 50 litres per minute, e.g. about 20 litres per minute, with the smallest one of the maximum flow rate to the rod-side chamber and to the piston-side chamber being 1000 litres per minute. For example, the maximum flow rate to the rod side chamber is smaller than to the piston-side chamber, e.g. 1000 litres per minute versus 2200 litres per minute.

Possible actions of the system when the monopile is being lowered toward the seabed by means of the crane 10 and being guided by the pile holding system 80 are:
1) If suddenly the pile top end moves inward at high speed or acceleration, tugger line pull will decrease faster than the tugger winch 31 can follow and the piston assembly 40b of the damping cylinder will extend by the accumulator pressure. The rod will follow the pile top end motion by quickly extending, thereby preventing slack rope on the tugger line 33a,b.
2) the pile top end moves outward at high speed or acceleration; tugger line pull will increase faster than the tugger winch 31 can follow and the piston assembly 40b of the damping cylinder will be pushed in by force. The hydraulic damping assembly will brake/dampen the outward motion.
Actions 1 and 2 will repeat and energy is dissipated until pile top end speed is in range of the tugger winch speed again. Then the damping assembly will balance out with the piston assembly 40b of damping cylinder in approx. the desired central position.

For example, once the seabed is reached by the monopile, the hydraulic damping assembly is switched off. For example, the damping cylinder is hydraulically locked by closing both flow control valves 61, 65. For example, once the hydraulic damping assembly is switched off, the tugger winches 31 are set at another constant tension set point than during the operative phase of the damping assembly.

In an embodiment of the bypass arrangement, a third flow control valve is arranged in the external bypass channel 70 allowing to open and close the external bypass channel as desired. In another alternative embodiment, a proportional relief valve is arranged in the external bypass channel allowing to open and close the external bypass channel.

In an embodiment of the accumulator assembly, this assembly is configured to selectively provide a high-pressure level pressurization of the hydraulic circuit and a low-pressure pressurization of the hydraulic circuit. For example, a first set of one or more accumulator units are filled with gas at a first or high pressure and a second set of one or more other accumulator units are filled with gas at a second or low gas pressure, and a selector valve assembly allows to selectively connect either the first set or the second set to the hydraulic circuit. The gas pressure is linked to the pressure in the chambers of the damping cylinder and therefore to the behaviour of the damping cylinder under varying loading by the associated tugger line.

In an embodiment, instead of providing the outrigger assembly, the one or more tugger lines 33a, b, each pass over a respective sheave on a trolley which is movable up and down along the boom of the crane.

In an embodiment, the one or more tugger winches are mounted on the deck 3 of the vessel, e.g. temporarily during certain operations wherein the use of the tugger assembly is desired.

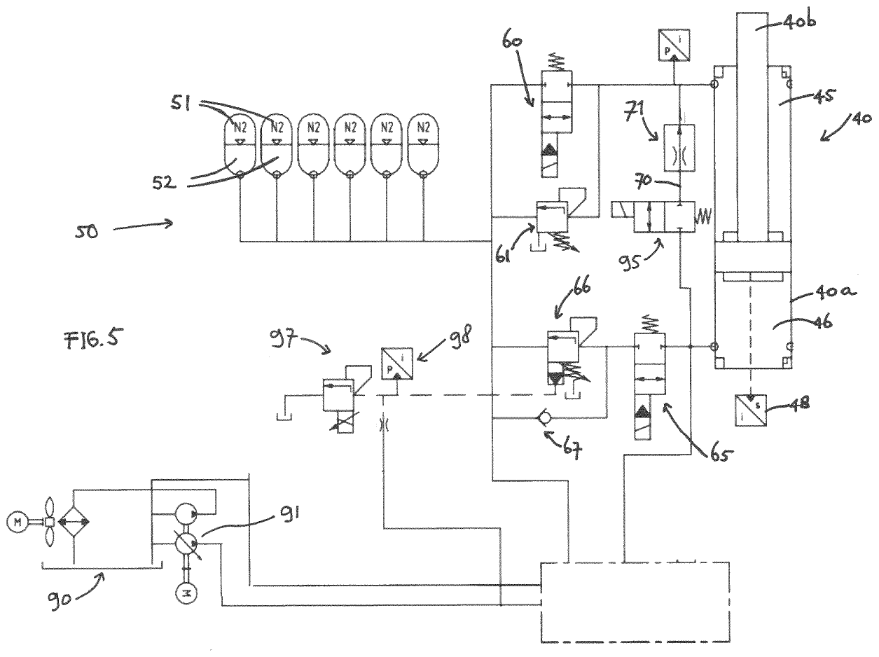

In an embodiment, as illustrated in FIG. 5, the hydraulics also include a tank 90 for hydraulic liquid as well as a motor driven pump 91 operable to pump liquid from the tank under pressure into the hydraulic circuit, e.g. allowing for—in combination with suitable control of the valves 61, 65, to bring the piston assembly in a desired position when the damping assembly is not operable. For example, the piston assembly is retracted inward when not in use.

In an embodiment, one or more pressure transducers, e.g. 98 in FIG. 5, are provided in the hydraulic circuit allowing to monitor the pressure of the hydraulic liquid.

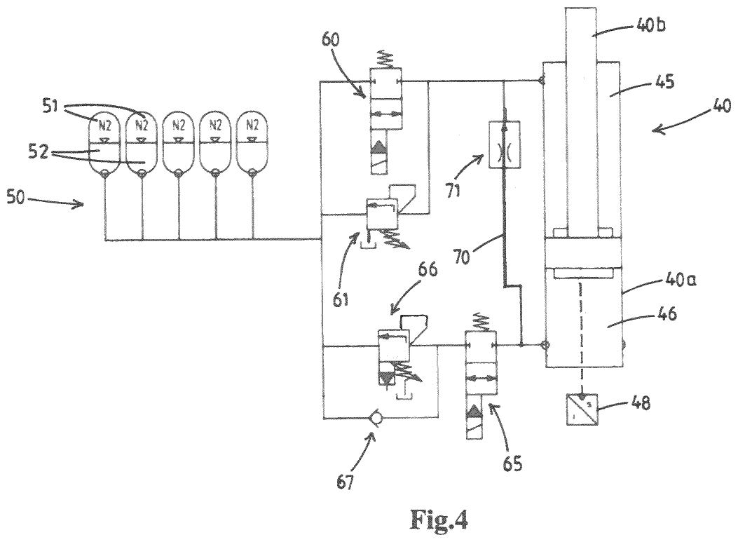

FIG. 5 illustrates a further developments of the damping assembly of FIG. 4.

The channel 70 can, in this example, be selectively opened and closed due to the presence of a controllable on/off valve 95 therein. This allows, when desired, to operate the damping cylinder 40 without a fluid flow through the channel 70.

FIG. 5 also illustrates a pressure control arrangement 97 configured to set the operating pressure in the hydraulic circuit.

1. A crane system for use on a vessel comprising:
a crane having a hoisting winch with an associated hoisting cable and a load connector for suspending an object; and
a tugger assembly comprising a tugger winch with an associated tugger line which is connectable to the object or to the load connector,
wherein the crane system further comprises a damping assembly having a damping cylinder supporting one or more sheaves over which the tugger line is guided between the tugger winch and the object or the load connector,
wherein the damping cylinder comprises a cylinder body and a piston assembly delimiting a rod-side chamber and a piston-side chamber of the damping cylinder, and
wherein movement of the object in the horizontal direction puts a load on the damping cylinder via the tugger line, the load on the damping cylinder moving the piston assembly of the damping cylinder, to thus dissipate kinetic energy of the object and damp motion of the object.

2. The crane system according to claim 1, wherein the damping assembly further comprises:
an accumulator assembly with a pressurized gas filled chamber and with a hydraulic chamber which is pressurized by the gas in the gas filled chamber via a medium separator of the accumulator assembly; and
a hydraulic circuit in communication with the hydraulic chamber of the accumulator assembly and connected to each of the rod-side chamber and the piston-side chamber of the damping cylinder,
wherein the hydraulic circuit comprises:
a first flow control valve to control flow between the rod-side chamber and the accumulator assembly;
a first pressure relief valve associated with the rod-side chamber and configured to prevent overpressurization of the rod-side chamber when the first flow control valve is closed;
a second flow control valve to control flow between the piston-side chamber and the accumulator assembly; and
a second pressure relief valve associated with the piston-side chamber and configured to allow for flow of hydraulic liquid out of the piston-side chamber upon reaching a threshold force of the tugger line on the piston assembly, and
wherein a bypass channel extends directly between the rod-side chamber and the piston-side chamber of the damping cylinder, and wherein a throttle is provided in the bypass channel.

3. The crane system according to claim 2, wherein the external bypass channel and the throttle in the external bypass channel are configured to provide for a maximum flow rate there through which is less than 10% of the smallest one of the maximum flow rate to the rod-side chamber and to the piston-side chamber of the damping cylinder.

4. The crane system according to claim 1, further comprising a control system to control damping motion of the object in a horizontal direction using the damping cylinder.

5. The crane system according to claim 4, further comprising sensors for measuring position, acceleration, and direction of movement of the object relative to the vessel, and
wherein the control system is configured to control the tugger assembly on the basis of measurements provided by the sensors.

6. The crane system according to claim 1, wherein the damping cylinder includes a position sensor which monitors the position of the piston assembly relative to the cylinder body,
wherein the tugger winch has a drive with a drive controller which is linked to the position sensor, and
wherein the drive controller is configured to control operation of the winch drive.

7. The crane system according to claim 1, wherein the damping cylinder is provided with a threshold pressure of at least 200 bar, such that the damping only occurs when the load on the damping cylinder exceeds the threshold pressure.

8. with a Vessel including a crane system according to claim 1.

9. The vessel according to claim 8, wherein the vessel is configured for installation of a monopile adapted to support an offshore wind turbine, the vessel comprising a pile holding system with a support structure mounted to the hull of the vessel and a pile holder supported by the support structure.

10. A method for installation of a monopile adapted to support an offshore wind turbine, wherein use is made of the vessel according to claim 9,
said method comprising:
suspending the monopile from the hoisting cable via a load connector in a substantially vertical orientation;
preferably connecting the tugger line to the object or to the load connector and operating the tugger line to dampen motion of the pile in a horizontal direction; and
lowering the monopile through a splash zone of a body of water, and damping motion of the monopile in a horizontal direction using the damping cylinder.

11. The method according to claim 10, further comprising:
measuring position, acceleration, and direction of movement of the piston assembly relative to the cylinder body; and
controlling the tugger winch and damping cylinder on the basis of measurements provided by sensors.

12. The method according to claim 10, further comprising:
holding the tugger winch non-rotative when horizontal movement of the object puts a load on the associated tugger line, said movement of the object thus causing compression or extension of the damping cylinder.
